(19) United States
(12) Patent Application Publication
(10) Pub. No.: US 2006/0244671 A1
(43) Pub. Date: Nov. 2, 2006

(54) Feeder waveguide and sector antenna

(75) Inventors: Keiichi Ohata, Tokyo (JP); Masaharu Ito, Tokyo (JP); Shuya Kishimoto, Tokyo (JP); Kenichi Maruhashi, Tokyo (JP)

Correspondence Address: FOLEY AND LARDNER LLP;SUITE 500, 3000 K STREET NW, WASHINGTON, DC, 20007, US

(73) Assignee: NEC Corporation

(21) Appl. No.: 10/556,726

(22) PCT Filed: Apr. 27, 2004
(86) PCT No.: PCT/JP04/06052

§ 371 Date: Apr. 28, 2006

(30) Foreign Application Priority Data
May 15, 2003 (JP) 2003-137283

(51) Int. Cl. H01Q 13/00

(52) U.S. Cl. 343/776

(57) ABSTRACT

In the sector antenna of the present invention, a feeder waveguide is formed that branches midway from a feeder port to each of a plurality of antennas. This feeder waveguide is formed from a waveguide tube and includes a main feeder line that extends from a waveguide that extends from the feeder port and branches in two directions, and branch feeder lines that each branch in two directions from the two ends of the main feeder line. Sector selection structures are provided for selectively shutting off each branch waveguide by effectively forming conductive walls for blocking the cross section of each of the branch waveguides at positions of each of the branch feeder lines that branch and extend from the main feeder line and from which each branch waveguide begins.

### TECHNICAL FIELD

The present invention relates to a feeder waveguide that is used in a radio communication device for microwave and millimeter wave bands and to a sector antenna that uses the feeder waveguide.

### BACKGROUND ART

In recent years, ultra high-speed radio communication systems such as wireless LAN or communication systems according to the IEEE 1394 standards have been realized that are capable of multimedia data transmission that includes moving pictures. Such systems are required to realize ultra high-speed data transmission of at least 100 Mbps at a low error rate. In order to avoid the occurrence of adverse influence upon communication resulting from multipath propagation, narrow-beam antennas are used and point-to-point communication is realized from a specific location to a specific location.

FIGS. 1A and 1B show a schematic view of a narrow-beam antenna of the prior art. This antenna is a planar antenna in which feeder port 53 is formed on one surface and antenna elements are formed on the other surface, FIG. 1A being a perspective view of this narrow-beam antenna as seen from the side of feeder surface 52, and FIG. 1B being a perspective view as seen from the side of antenna radiation surface 51.

A plurality of round elements arranged is formed on antenna radiation surface 51, whereby a slot array antenna is formed. A waveguide (not shown) is formed from feeder port 53 that is provided on the side of feeder surface 52 and toward antenna radiation surface 51. In this antenna, the supply of power from feeder surface 52 causes the emission of antenna radiation beam 54 having a strong directivity as shown schematically in FIG. 1B.

The antenna of the form shown in FIGS. 1A and 1B is disadvantageous in that it has poor usability such that it requires directional alignment of the antenna and is incapable of point-to-multipoint communication. One method that can be considered for solving these problems uses a sector antenna that integrates a number of antennas having antenna radiation beams that are directed in different directions. However, a sector antenna in which antennas are merely integrated has the drawback that transmission power is dispersed in each of the sectors, resulting in a shortening of the communication distance. One known method of ameliorating this problem involves enabling the selection of the sectors that are to supply the antenna radiation beam according to necessity.

FIG. 2 shows a schematic perspective view of a millimeter wave band sector antenna 71 of the prior art having a sector selection structure. In the example shown in FIG. 2, a pyramid structure is formed on carrier plate 72, and antenna elements are formed on each of the four side surfaces of this structure. As shown in the figure, an antenna is formed in which the antenna elements that are formed in each surface emit antenna radiation beams 64, each in a different direction for each surface.

One feeder port 63 is provided on carrier plate 72, and a waveguide is formed from this feeder port 63 to each antenna. The waveguide therefore branches midway to form a plurality of feeder distribution paths 73. A selection structure for determining whether or not power is supplied to each sector is formed by means of MMIC (monolithic microwave integrated circuit) 7 4 in each feeder distribution path 73 preceding the antenna of each sector. As a result, the operation of MMIC 74 in this sector antenna 71 selects the sector for supplying antenna radiation beam 64, whereby the radiation direction can be selected.

This type of sector antenna is also disclosed in, for example, JP-A-H11-225013. The sector antenna that is described in JP-A-H11-225013 has a construction in which the radiation beams that are emitted from a plurality of antenna elements are each directed in different directions using a conductor reflecting plate. The feeder waveguide to each antenna element begins from one feeder port, passes by way of MICs (microwave integrated circuits), and branches to a plurality of waveguides, whereby the operation of the MICs enables selection of the waveguide that is connected to antenna element to which power is to be supplied.

However, in the configuration of the example of the prior art that is described with reference to FIG. 2, the existence of the long feeder distribution paths 73 up to the selection structure for each sector, i.e., MMICs 74, results in leakage of transmission power to feeder distribution paths 73 other than that of feeder distribution path 73 to the selected sector and thus reduces the effective transmission power. There is the further disadvantage that the signal wave is reflected in MMICs 74 that are cut off, and these reflected signal waves interfere with and adversely affect the signal wave that is sent to the selected sector.

In the sector antenna that is described in JP-A-H11-225013, only the electrical circuits of each of the antenna switches that function as the selection structure are shown, and no consideration is given to the leakage of transmission power to non-selected feeder distribution paths nor to the adverse effect caused by reflection.

### DISCLOSURE OF THE INVENTION

It is an object of the present invention to reduce the leakage of power to non-selected branch waveguides and to reduce the adverse effects caused by reflection from non-selected branch waveguides in a feeder waveguide that has a plurality of branch waveguides and that allows selective supply of power to each branch waveguide. In addition, it is another object of the present invention to use the above-described feeder waveguide in the supply of power to each antenna of a sector antenna and thus provide a sector antenna that can transmit data both efficiently and with few errors.

To achieve the above-described objects, a feeder waveguide that has a plurality of branch waveguides branching from a feed side waveguide has selection structures for selectively cutting off each branch waveguide. These selection structures are arranged at the starting position of each branch waveguide at the point of branching from the feeder side waveguide to the plurality of branch waveguides.

By means of this configuration, when using the selection structures to cut off any of the branch waveguides that branch from one branch point, the branch point is essentially equivalent to a waveguide in which the branch waveguides that have been cut off do not exist. As a result, transmission power can be transmitted to the branch waveguide side that has not been cut off with virtually no leakage of transmission power to the branch waveguides that have been cut off and with virtually no reflection from the branch waveguides that have been cut off. According to another mode of the present invention, the selection structures are arranged at positions that are nλ/2 inside each branch waveguide from the starting position of each branch waveguide at the point of branching from the feed side waveguide to the plurality of branch waveguides, where λ is the wavelength of the transmission signal in the waveguide and n is a positive integer.

By means of this configuration, when using selection structures to cut off any of the branch waveguides that branch at one branch point, the transmission power advances into the branch waveguides that have been cut off but is reflected by the selection structures and is not transmitted beyond this point. The reflected wave that has been reflected by the selection structures that are in the cut-off state at this time has the same phase as the transmission signal at the starting positions of the branch waveguides, whereby the loss of the transmission power and the adverse effects caused by reflected waves can be reduced.

In the present invention, the feeder waveguide can be formed from waveguide tubes, whereby electromagnetic waves of short wavelength such as the millimeter waves that are used in ultra-high-speed communication can be transmitted with low loss.

In this case, the waveguide tubes may have an ordinary construction that is formed by conductive walls, but may also be constructed by forming conductive vias at a spacing smaller than λ/2, whereby the via rows in which the conductive vias are arranged substantially function as conductive walls that are continuous with respect to this transmission power, this function then being used to form pseudo-waveguide tubes from conductor walls that are effectively formed by the via rows and the metal layer within the dielectric board. The case of the latter construction it facilitates the formation of a desired waveguide on a dielectric board in a flat form, i.e., facilitates formation as a planar circuit.

When the waveguide is formed as waveguide tubes (including pseudo-waveguide tubes), the selective structures can be formed as constructions that cut off the waveguide by effectively forming conductive walls that block the cross-section of the waveguide tubes that constitute the branch waveguides.

More specifically, the selection structures can be formed from diodes that extend between opposing conductive walls that make up the waveguide tubes of the branch waveguides and circuits that selectively apply a reverse bias voltage or a forward bias voltage to the diodes. The application of a forward bias voltage to the diodes causes the diodes to function effectively as conductive vias. By appropriate arranging the diodes, the conductive vias that are effectively formed by the diodes effectively function as conductive walls that block the cross-section of the waveguide tubes that form the branch waveguides, whereby the selection structures assume the cut-off state. When a reverse bias voltage is applied to the diodes, the diodes have no effect on the transmission power that is transmitted inside the waveguide tubes and the selection structures therefore assume the open state. These diodes can be easily mounted on a dielectric board in a planar circuit construction.

As another mode, the selection structures can be constructed from conductive plates and structures that can selectively cause the conductive plates to move to positions that block the cross-section of the waveguide tubes that makes up the branch waveguides and to positions that open the waveguide tubes.

The sector antenna of the present invention is characterized in that it uses the above-described feeder waveguide as a feeder waveguide to a plurality of antennas each having directivity in a different direction. In this feeder waveguide, as described in the foregoing explanation, transmission power can be conducted to a selected branch waveguide while reducing the leakage of power to nonselected branch waveguides and the adverse effect of reflected waves from nonselected branch waveguides, and as a result, the sector antenna of the present invention can implement data transmission efficiently and with few errors.

In addition, a feeder waveguide can be formed from waveguide tubes, whereby the sector antenna of the present invention can be applied to ultra high-speed communication that uses electromagnetic waves of short wavelength such as millimeter waves. In particular, as described in the foregoing explanation, a construction in which rows of conductive vias and the metal layer in a dielectric board are used to form waveguide tubes facilitates the formation of a desired feeder waveguide as a planar circuit and then it facilitates the construction of a planar sector antenna.

As described in the foregoing explanation, the present invention can reduce both the leakage of power to nonselected branch waveguides and the adverse effects caused by reflected waves from nonselected branch waveguides in a feeder waveguide having branches, and further, enables the effective transmission of transmission power to only selected branch waveguides that is both efficient, and moreover, virtually free of the influence of reflection.

In the present invention, a waveguide can be formed from waveguide tubes, whereby the transmission of electromagnetic waves of short wavelength such as millimeter waves can be realized with low loss. In addition, virtually no effect of reflection occurs in the above-described waveguide tubes, whereby data transmission can be realized with few errors. The waveguide of the present invention can therefore be advantageously used in ultra high-speed radio communication.

A sector antenna that uses this type of feeder waveguide of the present invention can supply an antenna radiation beam in a selected direction at low loss and free of the effects of reflection and can realize data transmission at ultra high speed with few errors. In addition, the use of this sector antenna facilitates the alignment of the antenna direction and thus enables the implementation of point-to-multipoint communication.

### BRIEF DESCRIPTION OF THE DRAWINGS

FIG. 1A is a perspective view of a narrow-beam antenna of an example of the prior art as seen from the side of the feeder surface;

FIG. 1B is a perspective view of the narrow-beam antenna of FIG. 1A as seen from the side of the antenna radiation surface;

FIG. 2 is a perspective view of an example of a sector antenna of the prior art;

FIG. 3A is a perspective view of the sector antenna according to an embodiment of the present invention as seen from the side of the feeder surface;

FIG. 3B is a perspective view of the sector antenna of FIG. 3A as seen from the side of the antenna radiation surface;

FIG. 4A is a plan section of the sector antenna of FIG. 3A taken along a branch feeder line;

FIG. 4B is a vertical section of the sector antenna of FIG. 3A taken along a branch feeder line;

FIG. 5 is a perspective view of another sector antenna of the present invention as seen from the side of the feeder surface;

FIG. 6 is a vertical section taken along a branch feeder line showing the sector selection structures according to another configuration of the present invention; and

FIG. 7 is a vertical section taken along a branch feeder line showing the sector selection structure according to yet another configuration of the present invention.

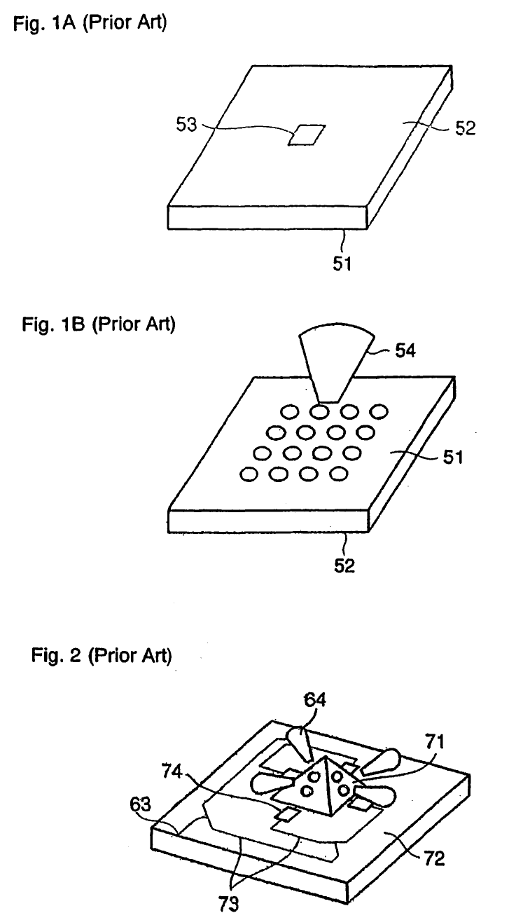

### BEST MODE FOR CARRYING OUT THE INVENTION

The following explanation regards an embodiment of the present invention with reference to the accompanying drawings.

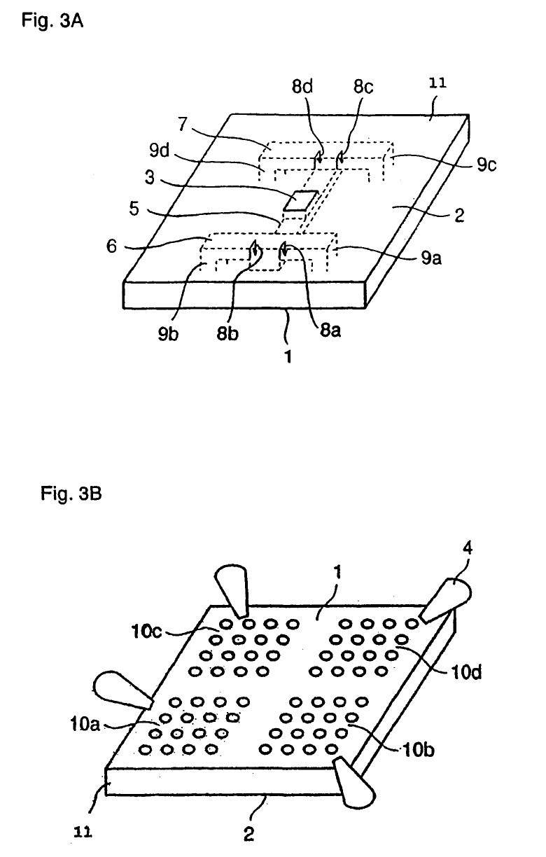

FIGS. 3A and 3B are schematic views of a feeder waveguide according to an embodiment of the present invention and a sector antenna that is provided with this feeder waveguide. The sector antenna of the present embodiment is a planar antenna in which feeder port 3 is formed on one surface of dielectric board 11 and antenna elements are formed on the other surface; FIG. 3A being a perspective view as seen from the side of feeder surface 2 and FIG. 3B being a perspective view as seen from the side of antenna radiation surface 1.

In this sector antenna, a plurality of round elements is formed as antenna elements. These antenna elements are formed aligned in arrays in each of four regions, whereby the rectangular antenna radiation surface 1 can be split in two in both the vertical and horizontal directions. The antenna elements that are formed in each region make up antennas of one sector: 10a, 10b, 10c, and 10d. Each of sector antennas 10a, 10b, 10c, and 10d may be either a patch array antenna or a slot array antenna, and in either case, each antenna has directivity in a different direction, as shown schematically by antenna radiation beam 4 in FIG. 3B. Accordingly, enabling the selective supply of transmission power to these antennas 10a, 10b, 10c, and 10d facilitates the aligning of the direction of the antennas, and further, enables application to point-to-multipoint communication.

The waveguides from feeder port 3 to each of antennas 10a, 10b, 10c, and 10d are formed by waveguide tubes that extend in dielectric board 11. As shown by the dotted lines in FIG. 3A, the waveguides that are realized by these waveguide tubes extend from feeder port 3 toward the antenna radiation surface 1 side, and then connect to main feeder line 5 that extends up and down in FIG. 3A. The two ends of main feeder line 5 connect to branch feeder lines 6 and 7, respectively, that each extends toward the right and left of FIG. 3A. The two ends of branch feeder line 6 connect to sector antenna feeder lines 9a and 9b, respectively, that pass toward antenna 10a and 10b, respectively. The two ends of branch feeder line 7 connect to sector antenna feeder lines 9c and 9d, respectively.

In the present embodiment, sector selection structures 8a, 8b, 8c, and 8d are provided at respective branch points, which are the portions of branching from main feeder line 5 toward branch feeder lines 6 and 7.

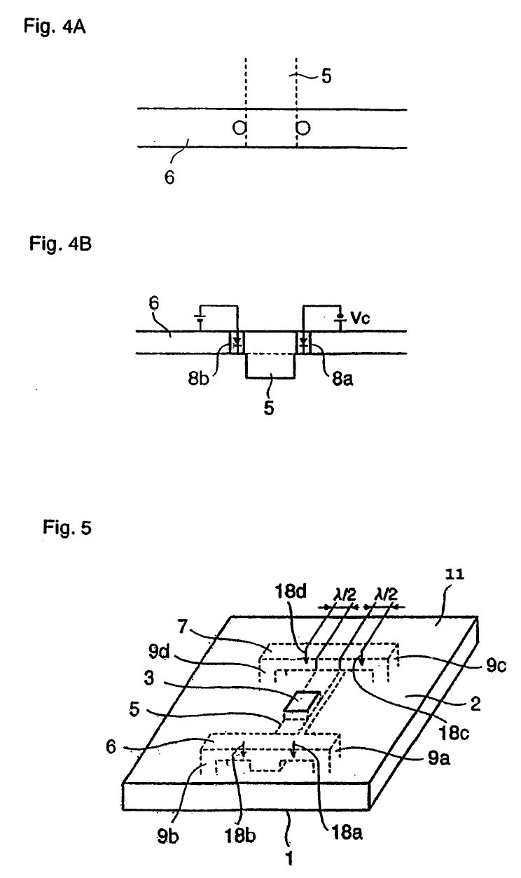

The explanation next regards the configuration of sector selection structures 8a, 8b, 8c, and 8d with reference to FIGS. 4A and 4B. FIG. 4A is a plan section taken along branch feeder line 6, and FIG. 4B is a vertical section.

In the present embodiment, sector selection structures 8a and 8b are made up by cylindrical diodes that are connected to circuits (not shown) for selectively applying a reverse bias voltage or a forward bias voltage. These diodes are arranged such that the spacing between the walls of the waveguide tube that constitutes branch feeder line 6 is smaller than λ/2, where λ is the wavelength of the transmission signal inside the waveguide.

In the example that is shown in FIGS. 4A and 4B, a forward bias voltage is applied to the diode of sector selection structure 8b, whereby the diode enters a conductive state. As a result, this diode effectively functions as a conductor, i.e., assumes a state in which a cylindrical conductive via is formed inside the waveguide tube. In addition, because the spacing between this diode and the walls of the waveguide tube that make up branch feeder line 6 is less than λ/2, this diode effectively functions as a conductive wall that blocks the cross-section of the waveguide tube with respect to the transmission power in the waveguide. Accordingly, in the state that is shown in FIGS. 4A and 4B, a conductive wall is formed effectively in branch feeder line 6 at the starting position, i.e., at the branch point, of the waveguide that branches from the side of main feeder line 5 toward the left side of FIGS. 4A and 4B. In other words, this branch point is cut off.

In contrast, a reverse bias voltage is applied to the diode of sector selection structure 8a, whereby the diode is a high resistance, and this diode therefore exerts no influence upon the transmission power that is transmitted inside the waveguide tube. In other words, the branch point from the side of main feeder line 5 toward the right side of FIGS. 4A and 4B is open. Accordingly, transmission power is selectively transmitted from the side of main feeder line 5 toward the right side of FIGS. 4A and 4B, is transmitted through sector antenna feeder line 9a, and conducted to antenna 10a. Because a conductive wall is formed effectively at the branch point by sector selection structure 8b in the portion from the side of main feeder line 5 toward the left side of FIGS. 4A and 4B as previously described, a bending but perfect waveguide tube is effectively formed in this portion, realizing a state that is equivalent to a case in which the branch waveguide directed toward the left side does not exist. As a result, there is substantially no leakage of transmission power to the branch waveguide that is directed from the side of main feeder line 5 toward the left side of FIGS. 4A and 4B and that passes to antenna 10b by way of sector antenna feeder line 9b, and there is substantially no reflection from this branch point.

Thus, when sector selection structures 8a, 8b, 8c, and 8d are placed in cut-off states, i.e., effectively form conductive walls at the branch points, the conductive walls that are formed can be arranged so as to form a portion of the tube walls of the waveguide tubes, whereby there is substantially no occurrence of reflected waves. In other words, sector selection structures 8a, 8b, 8c, and 8d are configured so as to effectively form conductive walls at the same surface as the surface along which extend the conductive walls that make up the waveguide on the feeder side. In the present invention, these positions are the branch points or the beginning positions of the branch waveguides at which selection structures are arranged.

Similarly, the selective application of a reverse bias voltage or a forward bias voltage to the diodes that make up sector selection structures 8c and 8d allows transmission power on the side of branch feeder line 7 to be selectively conducted to the selected side with virtually no leakage to the nonselected side or reflection from the nonselected side.

As described in the foregoing explanation, when sector selection structure 8a is opened on the side of branch feeder line 6, a forward bias voltage may be applied to both of the diodes that make up sector selection structures 8c and 8d to place both of sector selection structures 8c and 8d in the cut-off state. In this case, transmission power can be efficiently conducted to only antenna 10a. Here, reflected waves are generated toward main feeder line 5 from the side of branch feeder line 7 in which both selection structures 8c and 8d are cut off. The length from feeder port 3 of main feeder line 5 to branch feeder line 7 is preferably set to an integer multiple of λ/2. By means of this provision, the adverse influence caused by reflected waves and loss can be reduced because the transmission signal and the reflected waves have the same phase at the branch point of main feeder line 5 from feeder port 3 toward the upper side of FIG. 3A. The same holds true for the branch feeder line 6 side, and the length from feeder port 3 of main feeder line 5 to branch feeder line 6 is preferably made an integer multiple of λ/2.

As described in the foregoing explanation, according to the present embodiment, the provision of sector selection structures 8a, 8b, 8c, and 8d that effectively form conductive walls selectively at the branch points of branch feeder lines 6 and 7 from the main feeder line 5 side can reduce leakage of transmission power to, of the plurality of branch waveguides, nonselected branch waveguides and the reflection from the side of nonselected branch waveguides, and can effectively conduct transmission power to only the selected branch waveguide both efficiently and without loss, and moreover, free of the adverse influence caused by reflection from the side of nonselected branch waveguides.

In the present embodiment, moreover, waveguide tubes are adopted as the waveguides, whereby millimeter waves having, for example, a frequency of 60 GHz and a wavelength in free space on the order of 5 mm can be transmitted at low loss. Accordingly, the feeder waveguide and sector antenna of the present embodiment can be used advantageously in ultra high-speed radio communication devices that use millimeter waves.

The waveguide tubes may be a normal configuration that is enclosed by conductive walls so as to form paths having a rectangular cross-section, but may also be formed as a pseudo-waveguide tubes by conductive vias and the metal layer that are provided in a dielectric board 11. In other words, waveguide tubes can be formed by the metal layer and via rows by forming conductive vias in rows at a spacing of less than λ/2 and then taking advantage of the effective functioning of these via rows in which the conductive vias are aligned as continuous conductive walls with respect to the transmission power. This configuration is advantageous because waveguide tubes can be comparatively easily formed in planar dielectric board 11, whereby a feeder waveguide can be easily formed as a planar circuit. In addition, sector selection structures 8a, 8b, 8c, and 8d in the present embodiment are made up from cylindrical diodes, and these elements can also be easily mounted from the feeder port 3 side of dielectric board 11. Accordingly, the sector antenna and feeder waveguide of the present embodiment, particularly in the form in which pseudo-waveguide tubes are used, can be easily realized in an overall planar configuration and are extremely amenable to mass production.

The following explanation regards another embodiment of the present invention with reference to FIG. 5.

FIG. 5 is a perspective schematic view of the sector antenna of the present embodiment as seen from the side of feeder surface 2. In this figure, parts that are identical to parts in the above-described embodiment are given the same reference numerals and detailed explanation of these parts is here omitted.

In the present embodiment, the mounting positions of sector selection structures 18a, 18b, 18c, and 18d differ from those of the previously described embodiment. Specifically, sector selection structures 18a, 18b, 18c, and 18d are provided at positions shifted toward each branch waveguide from the branch points by λ/2 into each branch waveguide of branch feeder lines 6 and 7. In this configuration, the transmission power also advances into nonselected branch waveguides, but since the waveguide tubes are cut off at positions just λ/2 into each branch waveguide, the transmission power is reflected without being transmitted beyond these points. Because the reflected waves here have the same phase at the branch points as the transmission signal, no loss occurs and the transmission signal toward the selected side is not adversely affected.

As in the previously described embodiment, the configuration of this embodiment allows transmission power to be effectively conducted to only the selected branch waveguides with efficiency and without the occurrence of loss, and moreover, without the occurrence of the adverse influence caused by the reflection from the side of nonselected branch waveguides. Adopting the configuration of the present embodiment can raise the degree of design freedom.

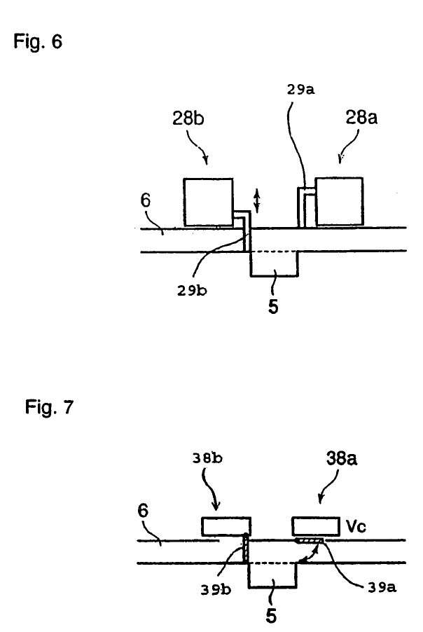

Although examples were described in each of the above-described embodiments in which cylindrical diodes were used as the sector selection structures, the present invention is not limited to this form. As other examples of configuration of the sector selection structures, FIGS. 6 and 7 show two examples of configurations in which waveguides are selectively cut off by means of conductive plates. FIGS. 6 and 7 are schematic vertical sections taken along branch feeder line 6.

FIG. 6 shows an example of a configuration in which conductive plates 29a and 29b are caused to move vertically with respect to branch feeder line 6 and thus be selectively inserted at branch points, the sector selection structure 28a side being in an open state with conductive plate 29a withdrawn from the interior of the waveguide tube, and the sector selection structure 28b side being in a cut-off state with conductive plate 29b inserted into the waveguide tube. Transmission power is thus selectively transmitted to only the side of sector selection structure 28a. These sector selection structures 28a and 28b can be configured by, for example, connecting metal plates to piezoelectric actuators as conductive plates 29a and 29b, and control can be realized by the selective application of voltage to the piezoelectric actuators.

FIG. 7 shows an example of a configuration in which conductive plates 39a and 39b have a rotational operation to selectively position conductive walls at positions that block the branch point; the sector selection structure 38a side being in the open state with conductive plate 39a rotated to a position along the tube wall of the waveguide tube, and the sector selection structure 38b side being in a cut-off state with conductive plate 39b rotated to a position that is perpendicular to the waveguide tube. The transmission power is thus selectively transmitted only to the sector selection structure 38a side. Sector selection structures 38a and 38b of this configuration can be formed using, for example, the MEMS (Micro Electro-Mechanical System) technology.

In the above-described invention, the positions of sector selection structures are at the branch points of the waveguide or at a position shifted nλ/2 inside each branch waveguide, but from the standpoint of ease of mounting each sector selection structure, a certain amount of tolerance is permissible in the mounting positions. As a range within which the desired characteristics are not appreciably diminished, this tolerance is preferably within the range of ±30% of λ/2. In addition, although an example was described in the above-described invention in which the invention was applied to a transmission circuit, the invention may also be applied to a reception circuit, in which case it should be clear that the invention can obtain the notable effects of both efficiently conducting received waves from a desired direction to a reception circuit and omitting the reception of unwanted waves.

1. A feeder waveguide that has a plurality of branch waveguides branching from a feed side waveguide and that is provided with selection structures for selectively cutting off each of said branch waveguides, these selection structures being arranged at a starting position of each said branch waveguide at a point of branching from said feed side waveguide to a plurality of said branch waveguides.

2. A feeder waveguide that has a plurality of branch waveguides branching from a feed side waveguide and that is provided with selection structures for selectively cutting off each of said branch waveguides at positions that are nλ/2 inside each said branch waveguide from a starting position of each said branch waveguide at a point of branching from said feed side waveguide to a plurality of said branch waveguides, where λ is a wavelength of a transmission signal in a waveguide and n is a positive integer.

3. The feeder waveguide according to claim 1, wherein said feeder waveguide is formed from a waveguide tube.

4. The feeder waveguide according to claim 3, wherein said waveguide tubes are formed from a metal layer in a dielectric board and conductive walls that are effectively formed by conductive vias that are mounted in rows at a prescribed spacing in said dielectric board.

5. The feeder waveguide according to claim 3, wherein said selection structures cut off a waveguide that form said branch waveguides by effectively forming conductive walls that block cross-sections of said waveguide tubes.

6. The feeder waveguide according to claim 5, wherein said selection structures are formed from: diodes that extend between opposing conductive walls that form waveguide tubes of said branch waveguides, and circuits for selectively applying a reverse bias voltage or a forward bias voltage to said diodes.

7. The feeder waveguide according to claim 5, wherein said selection structures are formed from conductive plates and structures that selectively cause said conductive plates to move to positions that block cross-sections of waveguide tubes that form said branch waveguides and to positions that open said waveguide tubes.

8. A sector antenna having a plurality of antennas each having directivity in a different direction and a feeder waveguide that branches midway from a feeder port and leads to each of said antennas, said sector antenna being provided with:
selection structures at a location of branching from a feed side waveguide to a plurality of branch waveguides of said feeder waveguide for selectively cutting off each of said branch waveguides at a starting point of each of said branch waveguides.

9. A sector antenna having a plurality of antennas each having directivity in a different direction and a feeder waveguide that branches midway from a feeder port and leads to each of said antennas, said sector antenna being provided with:
selection structures at a location of branching from a feed side waveguide to a plurality of branch waveguides of said feeder waveguide for selectively cutting off each of said branch waveguides at positions located nλ/2 inside each of said branch waveguides from a starting point of each of said branch waveguides, where λ is a wavelength of a transmission signal within said feeder waveguide, and n is a positive integer.

10. The sector antenna according to claim 8, wherein said feeder waveguide is formed from a waveguide tube.

11. The sector antenna according to claim 10, wherein said waveguide tubes are formed from a metal layer in a dielectric board and conductive walls that are effectively formed by conductive vias that are mounted in rows at a prescribed spacing in said dielectric board.

12. The sector antenna according to claim 10, wherein said selection structures cut off a waveguides that form said branch waveguides by effectively forming conductive walls that block cross sections of said waveguide tubes.

13. The sector antenna according to claim 12, wherein said selection structures are formed from: diodes that extend between opposing conductive walls that form waveguide tubes of said branch waveguides, and circuits for selectively applying a reverse bias voltage or a forward bias voltage to said diodes.

14. The sector antenna according to claim 12, wherein said selection structures are formed from conductive plates and structures for selectively moving said conductive plates to positions that block cross sections of waveguide tubes that form said branch waveguides and to positions that open said waveguide tubes.
